(19) United States
(12) Patent Application Publication
(10) Pub. No.: US 2024/0365716 A1
(43) Pub. Date: Nov. 7, 2024

(54) A RE-BALING APPARATUS, A BALE FORMER AND A RE-BALE FEEDER

(71) Applicant: SPREAD-A-BALE LIMITED, Vicars Cross, Chester (GB)

(72) Inventor: Michael HUGHES, Vicars Cross Chester (GB)

(21) Appl. No.: 18/573,236

(22) PCT Filed: Jun. 29, 2022
(86) PCT No.: PCT/GB2022/051676

§ 371 Date: Dec. 21, 2023

(30) Foreign Application Priority Data
Jun. 30, 2021 (GB) 2109450.3

(51) Int. Cl. A01F 29/00; A01F 15/10; A01F 17/00

(52) U.S. Cl. CPC A01F 29/005; A01F 15/10; A01F 17/00

(57) ABSTRACT

A re-bale feeder (10) comprising an open-topped box frame into which material is placed, a conveyor (12) within the box frame operative to urge the material in a longitudinal direction towards an exit end. Also disclosed is a bale former (30) comprising a rotating loading roller (31) with a plurality of radially extending members extending therefrom, a surround cage surrounding at least a forward side of the loading roller (31), the surround cage (33) having a plurality of opening therein to allow the radially extending members of the rotating loading roller (31) to extend therethrough during rotation of the loading roller (31), and a baling system to receive material loaded by the loading roller (31) and form the material into one or more bales and a bale assembly.

### TECHNICAL FIELD OF THE INVENTION

The present invention relates generally to the field of agricultural equipment. In particular, but not exclusively, the invention concerns a re-baling apparatus to reprocess conventional rectangular and round bales of hay and straw or the like, into smaller bales.

### BACKGROUND TO THE INVENTION

There is a significant of straw, hay and haylage, during the field production is initially made in large rectangular and round bales for field scale and transportation efficiencies. These large bales can be up to 2 m in width, 2 m in height and any length and when round, can be anywhere from 1 m to 3-4 m in diameter.

As will be appreciated, although these large bales are convenient for field scale and transportation, they are not particularly user-friendly due to their size.

Some traditional customers require smaller bales, typically around 20 kg to allow the customer to manually handle bales. Smaller, manually movable bales are used in the equine industry, pets, small holdings and the like, all across Europe and USA.

Embodiments of the invention seek to at least partially overcome or ameliorate any one or more of the abovementioned disadvantages or provide the consumer with a useful or commercial choice.

### SUMMARY OF THE INVENTION

According to a first aspect of the invention there is provided a re-bale feeder comprising an open-topped box chamber or frame into which material is placed, a conveyor within the box chamber or frame operative to urge the material in a longitudinal direction towards an exit end.

Providing a re-bale feeder as described allows a user to load a large bale of material and/or already separated material into the re-bale feeder to then be fed in a controlled manner to a bale former.

The re-bale feeder will typically be used with a bale former, with the exit end of the re-bale feeder aligned with an entry end or loading roller of the bale former. The exit end of the preferred box chamber or frame will typically correspond in width to the width of the loading roller of the bale former allowing radially extending members of the loading roller to be received at least partially within the exit end of the re-bale feeder.

The width of the loading roller of the bale former will typically correspond to the width of the exit end of the re-bale feeder.

The re-bale feeder may include an open-topped box chamber or frame into which material is placed. The box chamber or frame typically at least partially defines an internal volume into which separated material and/or one or more large bales are received. In a preferred embodiment, the chamber will typically have a pair of upstanding side walls, rear wall, and a base, with an open exit end. The open-topped box frame will typically have an open top.

In one form, the rear wall of the re-bale feeder may be movable.

If the rear wall is a movable rear wall, it is preferred that the rear wall pivots about a lower side edge to form a ramp to allow loading of at least one bale into the re-bale feeder from an end of the chamber opposite to spreader head. In one configuration, it is preferred that the ramp is a substantially planar member. Typically, the ramp/rear wall will extend across the width of the re-bale feeder. Preferably, the lower end of the ramp/rear wall is substantially coplanar with the base wall of the re-bale feeder and when lowered, will preferably angle downwardly.

The pivoting rear wall is simply one preferred embodiment of providing a movable rear wall and other configurations of movable rear wall may be provided, if preferred.

The base wall of the re-bale feeder may be substantially defined by the conveyor. In this form, the conveyor will preferably extend across the width of the internal volume and the length of the internal volume. A conveyor with an endless belt or similar may be preferred for moving separated material and still also be useful for baled material.

The conveyor will normally tend downwardly at a forward end thereof

In an alternative embodiment, a fixed, substantially solid base wall may be provided. The base wall may be located substantially transversely relative to the upstanding side walls and/or rear wall. The base wall will typically be spaced above a lower plane of the apparatus, which is preferably defined by a lower edge of the side walls. This configuration will preferably provide clearance beneath the underside of the base wall, above the lower plane of the apparatus.

Generally, the base wall and upstanding side walls of the re-bale feeder will define a substantially U-shaped profile with either a fixed rear wall, or a movable rear wall to at least partially define the chamber.

The base wall may be provided as a low friction surface. One or more runners or guides may be provided relative to an upper surface of the base wall and upon which the one or more bales can rest. The one or more runners or guides may be low friction runners or guides.

The re-bale feeder may include one or more bale chain drives. More than one bale chain drive may be provided. Each of the bale chain drives may be provided in the form of an endless chain with one or more engagement teeth extending upwardly from the chain within the re-bale feeder. This configuration is suitable for moving bales of material but is less useful if the material placed in the chamber is separated material.

In this configuration, the preferably solid base wall of the re-bale feeder will typically be provided with an elongate opening for each of the bale chain drives so that the engagement teeth can extend above the level of the base wall over a working length during rotation of the chain so that the engagement teeth of the chain engage a bale and drive the bale toward the exit end.

Any number of bale chain drives may be provided. In a preferred configuration, at least two bale chain drives are provided, one on either lateral side of the longitudinal midline of the re-bale feeder. The bale drives may be operated at different speed to ‘steer’ a bale as the bale is moved toward the exit end.

More than two bale chain drives may be provided depending upon parameters such as the configuration of the re-bale feeder, the size of the re-bale feeder, the type of bale to be spread and the like.

As mentioned above, each of the bale chain drives will typically extend longitudinally over at least a portion of the length of the re-bale feeder. Preferably the rear end of the bale chain drives will be located adjacent to and closely spaced from the rear wall of the chamber when closed, particularly in a rear loading configuration.

The chain part of the respective bale drive chains will preferably be mounted below the level of the preferably fixed base wall, so that only a portion of each of the engagement teeth mounted relative to the chain extend above the upper surface of the base wall. At the extremities of the preferred endless chain loop, the chain will preferably extend about the cog or sprocket, and the return portion of the chain would then typically extend beneath the cog or sprocket and under the base wall in space provided beneath the base wall and above the lower plane of the apparatus.

A cog or sprocket (for a chain drive) or other guiding member such as a drum for example (for the conveyor) will normally be provided at each respective ends of the re-bale feeder to drive and/or guide the rotation of the conveyor or chain drives. Preferably, each of the cogs/sprockets/drums will be provided with a number of teeth to engage the chain of the bale chain drive or conveyor and drive rotation of the chain or conveyor. In a preferred form, one of the cogs/sprockets/drums will be a drive cog/sprocket/drum and the other will be free rotating cog/sprocket/drum which rotates due to the rotation of the drive cog/sprocket/drum and being linked by the preferred endless chain or conveyor.

In some embodiments, both or more than one of the cogs/sprockets/drums associated with a single bale drive chain may be a drive cog/sprocket/drum.

Typically, a cog/sprocket/drum is provided a forward end of the re-bale feeder and a cog/sprocket/drum is provided at the rear end of the re-bale feeder. A cog/sprocket/drum is provided a forward end of the re-bale feeder and a cog/sprocket/drum is provided at the rear end of the chamber.

The cogs/sprockets/drums will preferably be provided in number of sets, with the cogs/sprockets/drums of each set mounted relative to a single shaft. Rotation of the shaft will preferably rotate each of the cogs/sprockets/drums in a particular set or vice versa.

Each of the bale chain drives and/or the conveyor can be driven in a forward and a reverse direction, as chosen by an operator. All of the bale chain drives of an apparatus are typically driven in the same direction and at the same speed to stop skewing of the bale as it is driven forward.

The forward end of the floor of the chamber may be mounted for pivotal movement up and down. The drive device such as a ram for example, may be provided attached to one end of one or more mounting arms which is/are mounted in over centre configuration relative to a shaft with an opposite end of the one or more mounting arms associated with a portion of the floor and/or the cowl. Raising and lowering the forward end of the floor and/or cowl can be undertaken to adjust the angle at which the material leaves the exit end of the re-bale feeder.

It is preferred that any drive motor provided on the re-bale feeder is mounted relative to one of the side walls of the chamber head, relative to an outer surface of the side wall.

The drive motors are typically connected to a hydraulic circuit of a loader or tractor.

Where a drive motor is provided, the drive motor is typically provided with a drive cog or sprocket. A toothed belt may be provided to connect the drive cog or sprocket with a cog or sprocket associated with at least one end of shaft. Alternatively, the drive motor may drive a drive shaft directly, the drive shaft mounting one or more cogs/sprockets/drums.

In one preferred embodiment, the rear shaft is a driveshaft rotated by the drive motor.

The re-bale feeder is preferably constructed on a chassis formed from a pair of spaced apart, elongate side rails. The walls ware typically mounted to an upper side of the side rails. The conveyor or chain drives are typically mounted between the side rails.

One or more transverse members may be provided extending between the side rails. A pair of hollow members may be provided extending between the side rails to receive the tines of lifting apparatus to allow movement of the re-bale feeder.

A filler member may be provided substantially coplanar with the conveyor or chain drives at the rear of the chamber to span any distance between the rear end of the conveyor or chain drives and the rear wall of the chamber. This may help to prevent any material being lost between the rear end of the conveyor or chain drives and the rear wall of the chamber.

The re-bale feeder may be associated with one or more additional optional extra processing devices.

One or more bale separators may be associated with the re-baler. A bale separator may comprise one or more rotatable shafts, a series of blades being mounted on at least one of said shafts. The baled material can be fed into the separator to break up the material in the bale to allow easier processing by the re-bale feeder.

In one form, the separator includes an external frame with at least one horizontally mounted rotatable shafts, a series of blades being mounted on at least one of said shafts. Typically, a pair of shafts are provided. The pair of shafts are coplanar and spaced apart. The shafts are typically both driven in rotation. The shafts may counterrotate. The blades on the respective shafts will normally interleave with one another. The blades on the respective shafts typically cooperate to span the gap between the shafts to break up the baled material.

Optionally no more than two blades are provided in any line of circumference on the shaft. In other words, more than one blade is preferably provided but preferably there are no more than two blades which are radially aligned in any single plane. If four blades are provided, they would all be offset radially or two blades would be aligned in one radial plane and the other two blades would be aligned in another radial plane. If more blades were provided, then they could all be offset from one another or provided in pairs aligned in a radial plane with each pair of set.

Preferably, laterally adjacent blades will be radially offset from one another.

Optionally a pair of blades are provided as the respective opposite tips of an elongate member extending around and from opposite sides of the shaft.

Optionally blades are spaced apart along the shaft. In one embodiment, the blades are evenly spaced apart on the shaft.

Optionally adjacent blades are spaced apart along the shaft by 10 cm to 20 cm. In one embodiment this distance is 15 cm.

Optionally the tips of the blades are spaced apart from the centre of the shaft by a length between 40 cm and 60 cm. In one embodiment this distance is 50 cm. Depending upon the height of the apparatus and/or the height of the bale, the shaft mounting the blades may be movable up and down during spreading. Preferably, the shaft may be driven up and down. Any movement of the shaft relative to which the blades are mounted will typically be linear. Preferably, the movement of the shaft will reciprocate.

Optionally the blades are each set at 45° to an adjacent blade on the shaft.

Optionally the blades are arranged such that a blade tip is provided every 45° around the shaft, when viewed along the shaft.

Optionally one motor drives rotation of a single shaft and all of the blades mounted relative to the blades.

Each of the blades may be mounted relative to the shaft through provision of a rotor arm. Each rotor arm is preferably located on the rotatable shaft. The rotor arms are preferably planar. The rotor arms preferably extend on each side of the rotatable shaft approximately equally. A substantially central aperture through which the rotatable shaft extends is preferably provided through the rotor arm.

Each free end of each rotor arm is provided with or forms a blade for shredding the bales. The blade may be formed separately and attached relative to the free end of the rotor arm.

Each blade will preferably be shaped to optimise the breakup of the bale. Each blade will preferably be elongate. Each blade will preferably have a planar forward edge and a planar rear edge (in the direction of rotation). The tip of each blade will preferably be arcuate. In a preferred form, the tip will curve toward the root of the blade, rearwardly (relative to the direction of rotation).

The blade may be twisted or shaped relative to the direction of rotation.

More than one separator may be provided. For example, two separators may be provided in a vertical stack. Typically, the stack is provided above the chamber of the re-bale feeder so that gravity can feed the separated material into the chamber of the re-bale feeder. The separators may be offset with the shafts in one of the separators angled relative to the shafts in the other of the separators.

A hopper may be provided above the stack.

The stack may be fed in any way. For example, a bale handling apparatus such as that described in PCT/GB2020/051334 could be used to provided feed material from a larger bale, into the hopper, stack and/or chamber. Alternatively, a conveyor could be used in a larger, fixed assembly.

According to a second aspect of the invention there is provided a bale former comprising
a rotating loading roller with a plurality of radially extending members extending therefrom,
a surround cage surrounding at least a forward side of the loading roller, the surround cage having a plurality of openings therein to allow the radially extending members of the rotating loading roller to extend therethrough during rotation of the loading roller, and
a baling system to receive material loaded by the loading roller and form the material into one or more bales.

Providing a bale former with the surround cage allows the bale former to accept material and bale the material into smaller bales whilst minimising wrapping of the material about the rotating loading roller.

The bale former is typically used with a re-bale feeder. The bale former is preferably powered by hydraulics. Typically, the hydraulic circuit used will be the same as that used to power the re-bale feeder.

Typically, the speed of the re-bale feeder will be matched to the processing speed of the bale former in order that material does not build up in the re-bale feeder and/or the bale former, particularly around the loading roller.

The bale former may include a rotating loading roller with a plurality of radially extending members extending therefrom. The loading roller will typically collect material to provide to the baling system, preferably ensuring that the material is separated to a degree allowing processing by the baling system. It is usually more efficient to form a bale from a smaller amount of material and adding to that amount as necessary, than attempting to reduce the size of material in the bale former, to form a bale.

The rotating loading roller will normally include a central shaft or drum. The central shaft or drum will normally be substantially cylindrical, although any shape could be used.

The loading roller is typically laterally extending. The loading roller will normally be horizontal. The loading roller will normally be provided substantially perpendicularly to any feed of material, which in a preferred form includes the conveyor of the re-bale feeder.

The loading roller will typically rotate counterclockwise. The loading roller will normally be rotating upwardly at an entry side of the loading roller.

Usually, a single loading roller is provided.

A plurality of radially extending members is typically provided extending from the loading roller. The radial extending members will typically be spaced over the length of the loading roller. The radial extending members will typically be spaced circumferentially around the loading roller.

The radially extending members will typically be elongate. The radially extending members may have any shape. The radially extending fingers typically feed a conveyor which preferably forms part of the baling system in order to feed material to the baling system.

The radially extending members may be strengthened or reinforced given that a tip region of each of the radially extending members will typically experience more force than the root of each of the radially extending members, as the radially extending members move the material.

The conveyor which feeds the baling system may be of any type. For example, a belt conveyor could be used but mailing systems typically use a screw conveyor or ram to move material into the baling system in order to prevent material moving backwardly out of the baling system. In one form, the conveyor which feeds the baling system will drive material laterally relative to the loading roller, into the baling system.

In an embodiment, a screw conveyor is located relative to an upper side of the surround cage, above the loading roller in order to move material laterally across an upper portion of the surround cage, and into the baling system.

The conveyor which feeds the baling system may however be in any suitable position relative to the loading roller and the baling system.

A transverse rail or similar may extend above the loading roller. The rail will typically be substantially parallel to the loading roller. The rail will normally be spaced above the loading roller and toward the feed of material. A number of elongate members or fingers may extend from the rail, rearwardly toward the loading roller. The elongate members or fingers will typically function to hold the material which is lifted by the radially extending members of the loading roller, downwardly onto an upper side of the surround cage to allow the material to be collected by the conveyor feeding the baling system. The elongate members or fingers may be angled downwardly and/or rearwardly toward the loading roller. The elongate members or fingers will preferably be interleaved with the radially extending members on the loading roller so that the elongate members or fingers do not obstruct or strike the radially extending members on the loading roller as the loading roller rotates.

The bale former may include a surround cage surrounding at least a forward side of the loading roller, the surround cage having a plurality of openings therein to allow the radially extending members of the rotating loading roller to extend therethrough during rotation of the loading roller.

The surround cage will typically prevent or at least minimise the separated material wrapping about the loading roller.

A feed side of the surround cage will preferably be arcuate or curved.

An upper portion of the surround cage may be flattened to allow material collected by the radially extending members of the loading roller to be deposited on top of the surround cage to then be collected or moved by the conveyor.

The lower portion of the surround cage may be flattened as well but this is less important.

The surround cage will typically be formed from a number of spaced apart members. An opening will preferably be provided between adjacent spaced apart members to allow the radially extending members of the rotating loading roller to extend therethrough during rotation of the loading roller. The openings will typically be closely dimensioned, at least at a forward and upper side of the surround cage. This may reduce the amount of material falling through the openings whilst the material is being moved. The openings may be convergent at a lower side in order to guide of the radially extending members of the loading roller into the openings.

An outer surface of each of the spaced apart members may be planar. Providing planar spaced apart members may assist with removal of the material from the radially extending members of the loading roller.

The surround cage and/or the spaced apart members will typically be manufactured of metal or similar robust material.

The radially extending members on the loading roller will typically collect material from the conveyor of the re-bale feeder and lift the collected material into a position in which the conveyor which feeds the baling system of the bale former can act to move the material into the baling system. The radially extending members may assist with separation of material as the material is being collected and/or moved to the conveyor which feeds the baling system.

The bale former may include a baling system to receive material loaded by the loading roller and form the material into one or more bales.

Any suitable baling system may be used. Many suitable baling systems or machines are produced by INT HARVESTER CO, for example those disclosed in U.S. Pat. No. 3,110,246 or United Kingdom Patent No. GB1504785.

According to a third aspect of the invention there is provided a re-baling apparatus comprising:
a) a re-bale feeder as described above; and
b) a bale former positioned relative to the exit end of the re-bale feeder to receive material and form the material into one or more bales.

Providing a re-baling apparatus as described allows a user to load a large bale of material and/or already separated material into the re-bale feeder and have the bale former collect and bale the material into smaller bales.

In an embodiment, the lowered exit end of conveyor of the re-bale feeder is located partially below the radially extending members of the rotating loading roller allowing the radially extending members of the rotating loading roller to collect the material and move the collected material from the re-bale feeder and into the bale former.

In an embodiment, the re-baler assembly may be towed behind a tractor or similar driven vehicle (not shown), where the pick-up reel is offset and the tractor drives alongside the swath (row) of straw or hay or haylage which is being baled in the field. The pickup reel picks up the straw or hay or haylage in the swath and lifts it to be dropped into the hopper.

In this embodiment, the tractor may be positioned alongside the re-baler. Any feed hopper may be flat on the tractor side (so as not to interfere with the tractor). The tractor preferably drives the re-baler from its external hydraulic services. Preferably a double acting two-way spool valve may be provided to a hydraulic manifold on the re-baler. The hydraulic manifold may control a motor driving the speed of a belt feeding the bale former and also control the speed of the rotors provided to break down bale wafers/sections.

Double rotor agitators may be provided in a housing on one or more levels. The double rotor agitators are spaced apart, preferably by 400-500 m. This may provide clearance between rotors. One or more a tine bars mounting a plurality of spaced apart tines may be provided to direct the straw/hay towards the centre of the belt of the re-baler. The tines are preferably located to fit between the blades of the rotor, enabling variable resistance with the rotors to break down the wafers depending on the bale and wafer material and type as grass hays have very different characteristics to cereal straws for example. The bale material therefore may require different settings to the tines and/or the rotors. For example, grass hays may require 2-3 pairs of double outwardly counter rotating rotors to break bale wafers apart.

One or more sets of tines may be provided below the rotors to deflect the loosened material towards the centre of the feeding the bale former.

A set of horizontal tines may be provided at an upper part of the re-baler chamber (within the chamber), after the feed of the bale material to gently compress the swath of material against the base wall or belt of the re-baler.

One or more sets of set of vertical tines may be provided within the re-baler chamber to narrow the swath and/or provide a more consistent feed swath the bale former. Without wishing to be limited by theory, it is important to present an even consistent swath to the bale former as failing to do so can form misshapen bales (like sausages, which will prove very problematic to any automated bale handling system, i.e. bale packers, bent bales cause havoc and mayhem after re-baling, so swath shape and structure is critical to a successful re-baling operation). Creating of an even field swath, to replicate an inside factory environment, makes the tines and deflectors critical to swath management.

An inline re-bale assembly may be provided with a power take off shaft to attach to the driven vehicle and to the baler. A structural box member or frame may be provided to mount the bale former to the re-baler to the bale feeder to the tractor or driver vehicle, in a static or fixed configuration.

In embodiment, the take-off off shaft may extend through the a structural body or chassis of the re-bale feeder.

A structural member, for example an elongate structural box member may be used, extending through the structural body of the re-bale feeder and through which the power take-off shaft extends.

A hopper may be provided above a rectangular body or chassis through which the power take-off shaft extends.

The power take-off shaft may be divided into multiple parts with an articulated joint between each part.

In an embodiment, a first part of the power take-off shaft preferably connects to the power take-off of the tractor or driver vehicle. A second part of power take off shaft preferably connects to the bale former at the opposite end of the re-baler to the tractor or driven vehicle. A third part of power take off shaft may be provided extending across the re-bale feeder, preferably within a structural box member which protects the third part from the bale material. Providing counterrotating double rotor agitators (rotating up in the centre and downwardly at the outside) in the re-bale feeder of this embodiment may divert bale material around the power take off shaft extending across the re-bale feeder and may also help to centre the bale material on the belt of the re-baler.

### DETAILED DESCRIPTION OF THE INVENTION

In order that the invention may be more clearly understood one or more embodiments thereof will now be described, by way of example only, with reference to the accompanying drawings, of which:

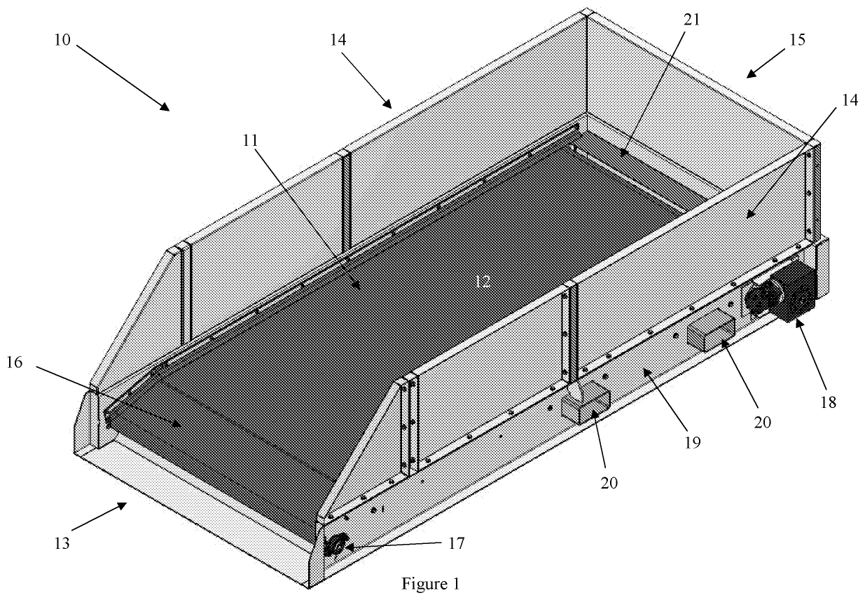

FIG. 1 is an isometric view of a re-bale feeder according to an embodiment.

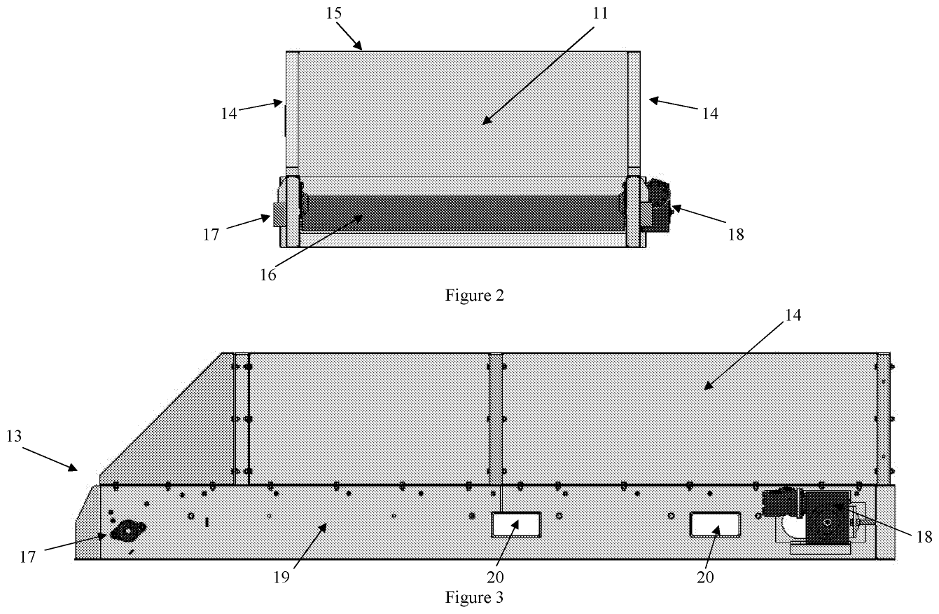

FIG. 2 is an end view from the exit end of the re-bale feeder illustrated in FIG. 1.

FIG. 3 is a side view of the re-bale feeder illustrated in FIG. 1.

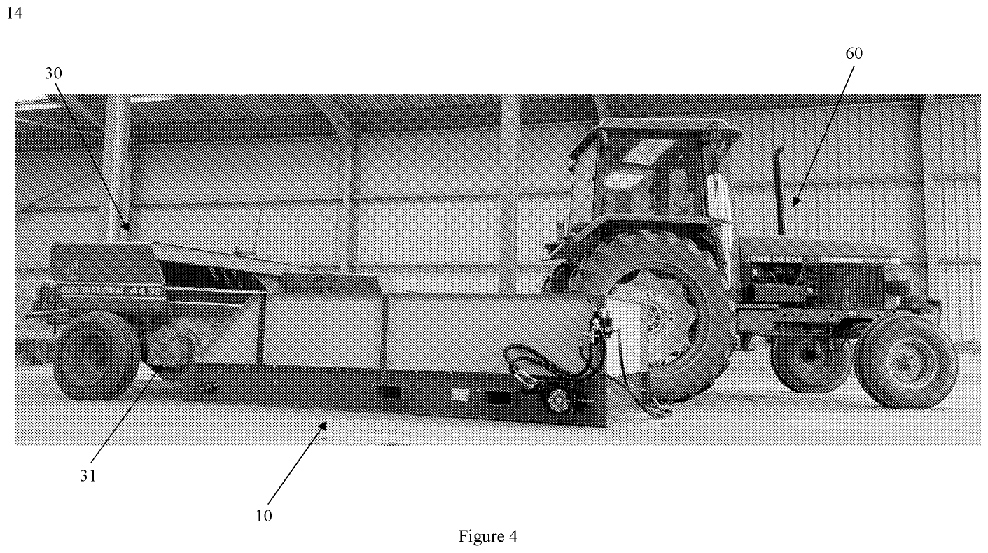

FIG. 4 is a side view of a re-baling apparatus according to an embodiment.

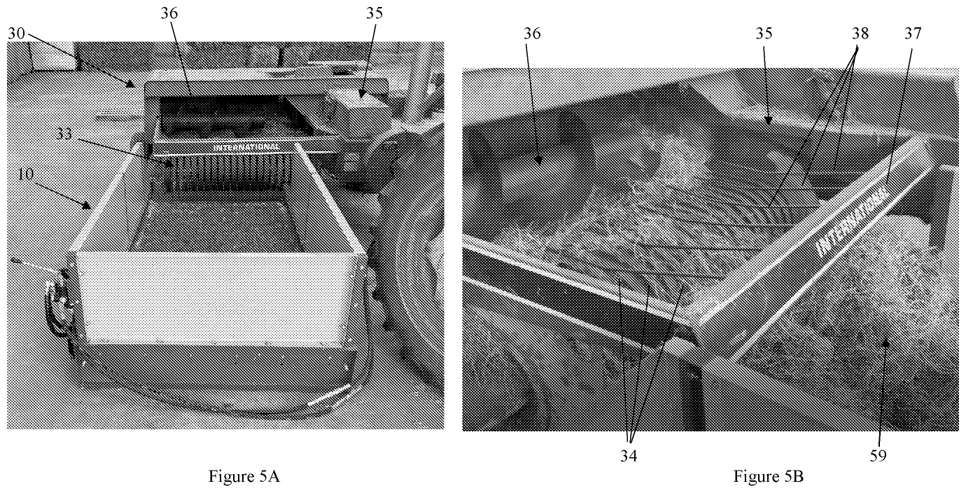

FIG. 5A is a view from the rear of the re-baling apparatus illustrated in FIG. 4.

FIG. 5B is a detailed isometric view of the interface between the re-bale feeder and the bale former illustrated in FIG. 4.

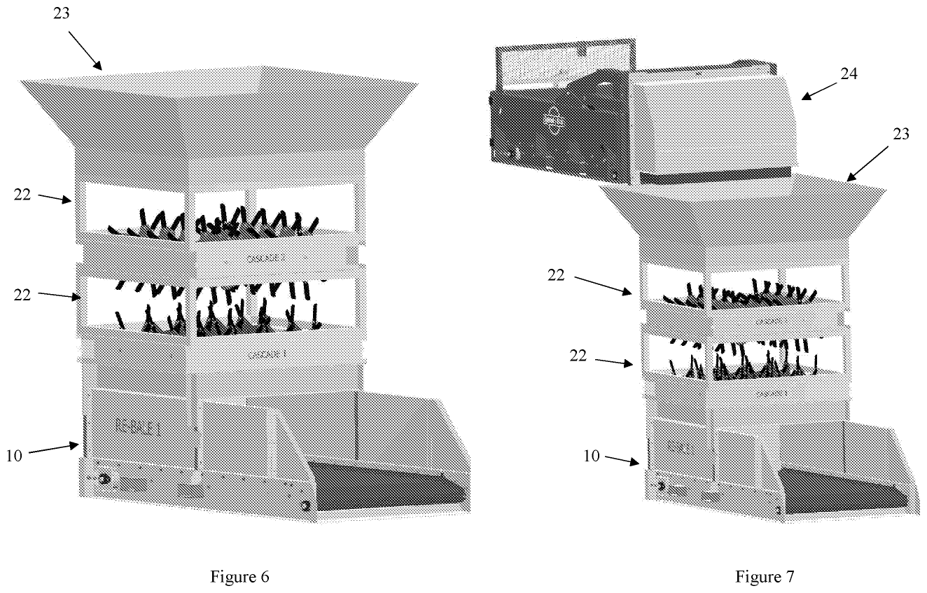

FIG. 6 is an isometric view of an alternative re-bale feeder configuration.

FIG. 7 is an isometric view of the re-bale feeder configuration illustrated in FIG. 6 with a bale spreader positioned rearwardly.

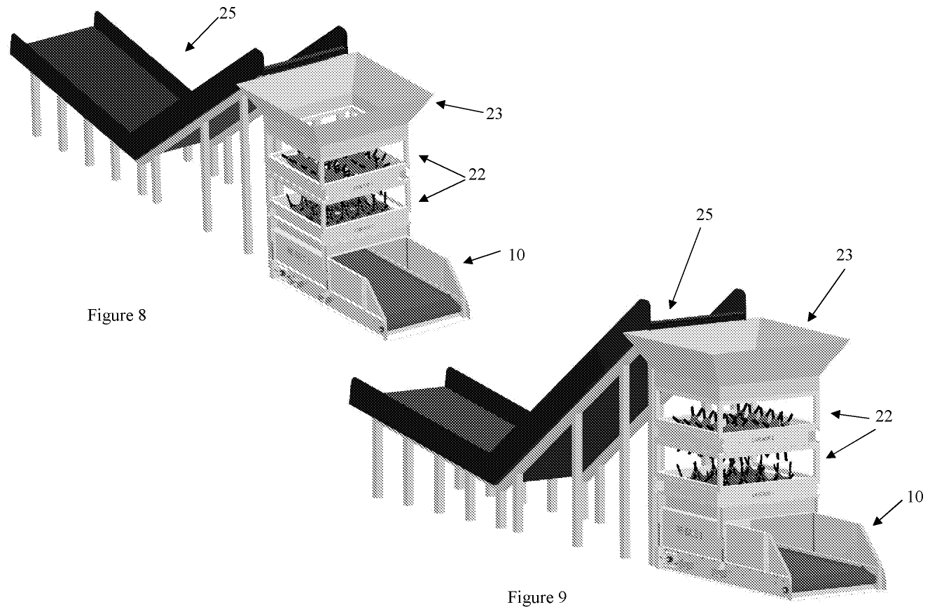

FIG. 8 is an isometric view of the re-bale feeder configuration illustrated in FIG. 6 with a supply conveyor positioned rearwardly.

FIG. 9 is an alternative view of the configuration shown in FIG. 8.

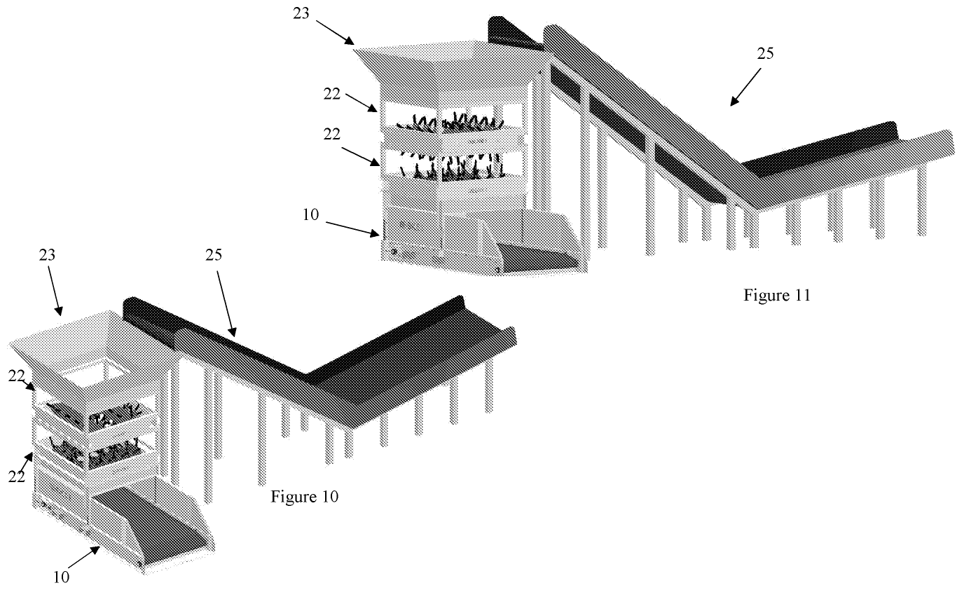

FIG. 10 is an isometric view of the re-bale feeder configuration illustrated in FIG. 6 with a supply conveyor positioned on the right side.

FIG. 11 is an alternative view of the configuration shown in FIG. 10.

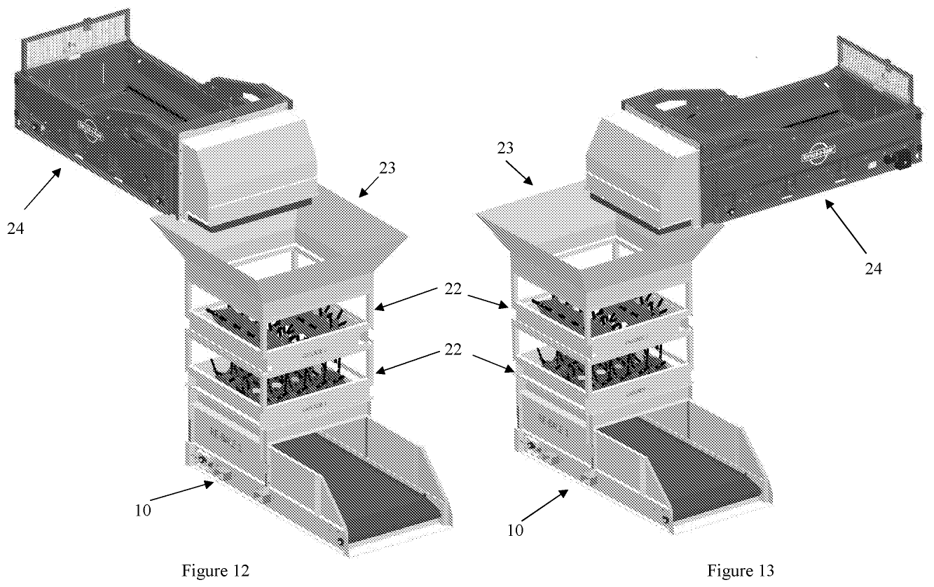

FIG. 12 is an alternative view of the configuration shown in FIG. 7.

FIG. 13 is an isometric view of the re-bale feeder configuration illustrated in FIG. 6 with a bale spreader positioned on the right side.

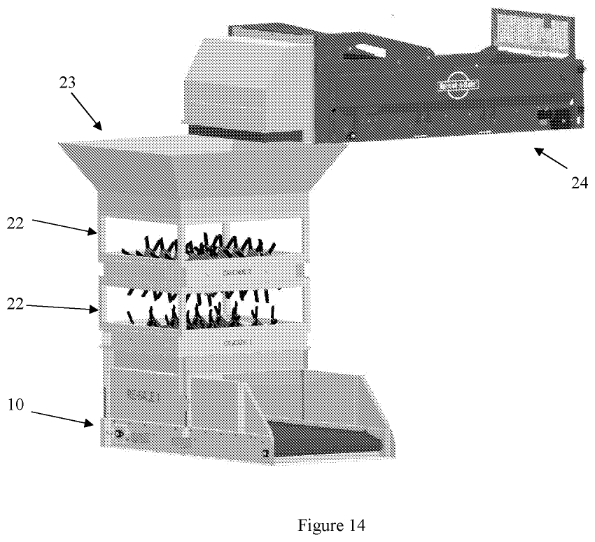

FIG. 14 is an alternative view of the configuration shown in FIG. 13.

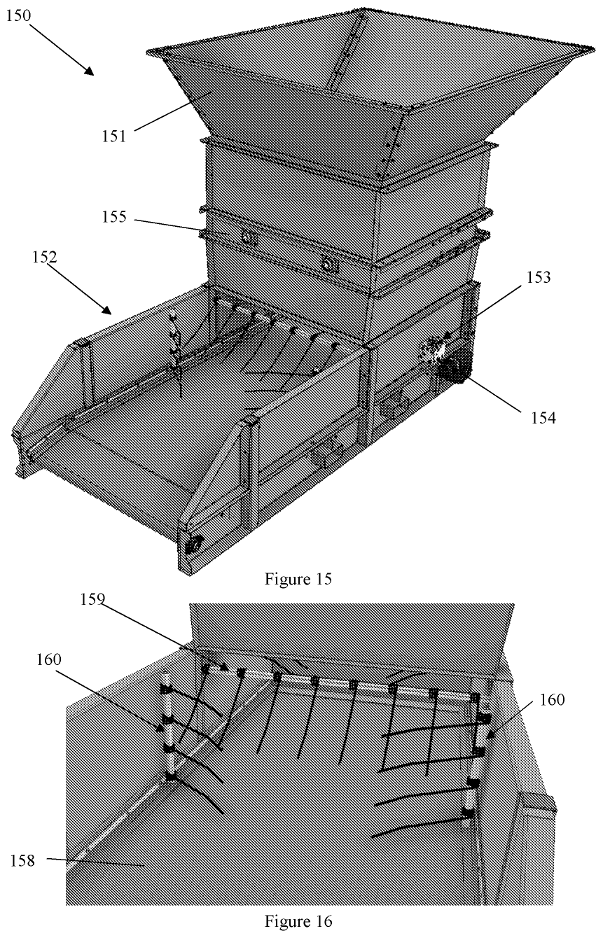

FIG. 15 is an axonometric view of a re-bale assembly with a re-bale feeder having a single level according to an embodiment.

FIG. 16 is an end view of the re-baler shown in FIG. 15.

FIG. 17 is a top view of the re-bale feeder illustrated in FIG. 15 showing the double rotor agitators to break up a bale.

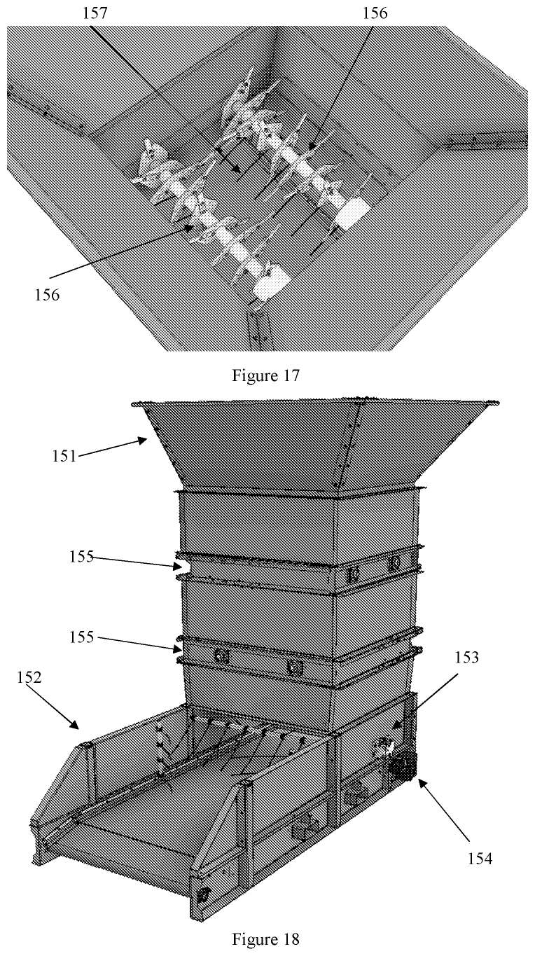

FIG. 18 an axonometric view of a re-bale assembly with a re-bale feeder having a pair of offset levels according to a further embodiment.

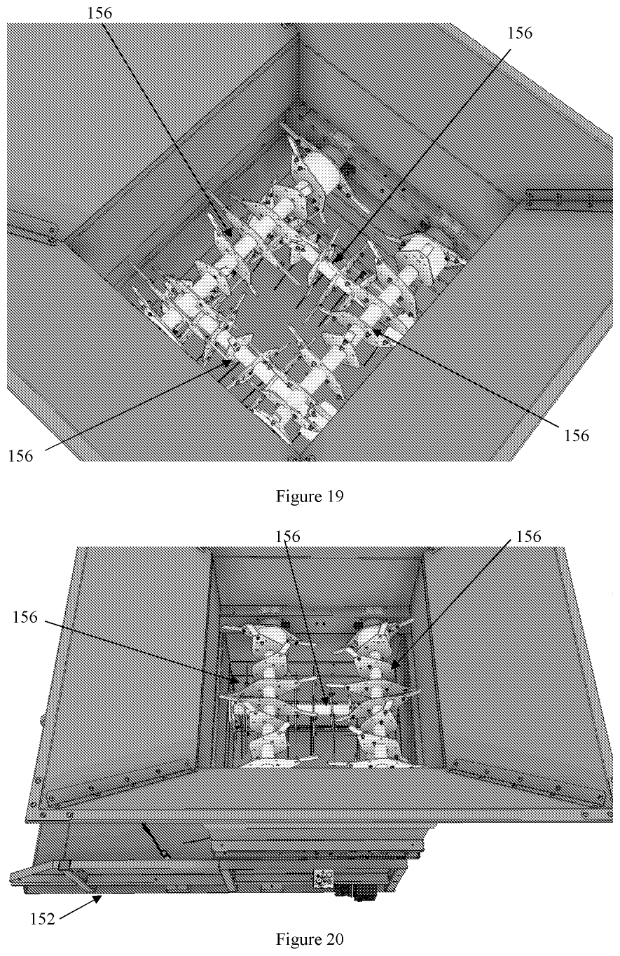

FIG. 19 is a top view of the re-bale feeder illustrated in FIG. 18 showing the two offset levels of double rotor agitators to break up a bale.

FIG. 20 is an angled view of the configuration shown in FIG. 19.

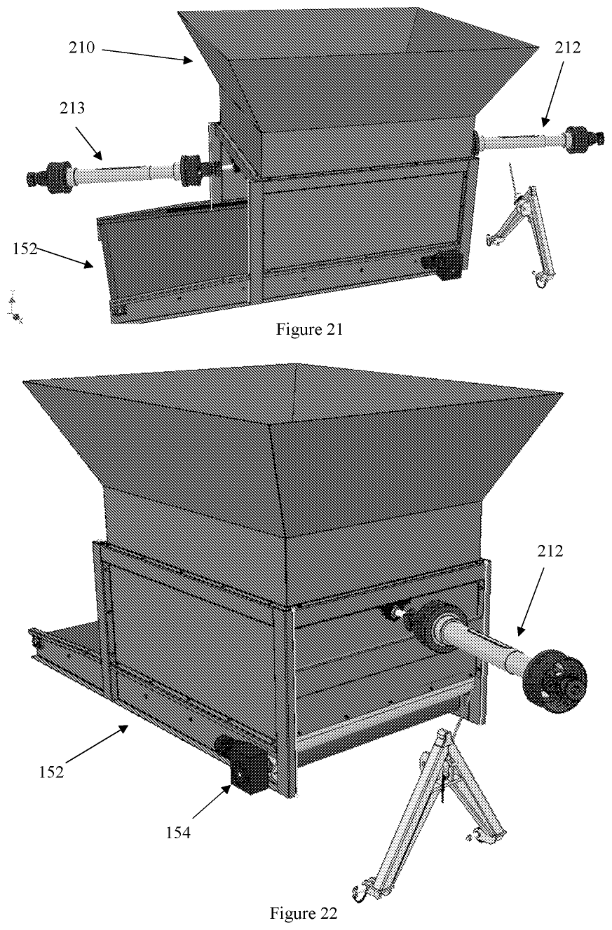

FIG. 21 is an axonometric view of an inline re-bale assembly with power take off to attach to the driven vehicle and the baler of an embodiment.

FIG. 22 is a view from the forward end of the inline re-bale assembly illustrated in FIG. 21.

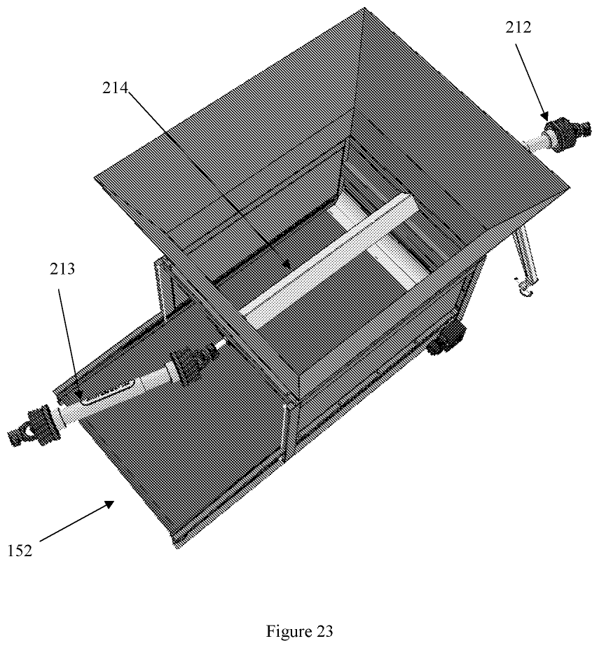

FIG. 23 is a top view of the inline re-bale assembly showing the structural box member extending through the re-bale feeder (with the rotor agitators removed for clarity).

With reference to the accompanying figures, a re-bale feeder 10 comprising an open-topped box chamber 11 into which material is placed, and a conveyor 12 within the box chamber 11 operative to urge the material in a longitudinal direction towards an exit end 13.

The re-bale feeder 10 will normally be used with a bale former 30 as shown in FIGS. 4 to 5B, with the exit end 13 of the re-bale feeder 10 aligned with an entry end or loading roller 31 of the bale former 30. As illustrated best in FIG. 5A, the exit end 13 of the box chamber 11 corresponds in width to the width of the loading roller 31 of the bale former 20 allowing the radially extending members of the loading roller 31 to be received at least partially within the exit end 13 of the re-bale feeder 10.

The re-bale feeder 10 illustrated has an open-topped box chamber 11 into which material is placed. The box chamber 11 defines an internal volume into which separated material and/or one or more large bales are received. In the illustrated embodiment, the chamber 11 has a pair of upstanding side walls 14, rear wall 15, and a base, with an open exit end 13. The chamber 11 has an open top.

The base wall of the illustrated chamber 11 is substantially defined by the conveyor 12. The conveyor 12 is an endless belt conveyor, extending across the width of the internal volume and the length of the internal volume.

The conveyor will normally tend downwardly at a forward end 16 thereof as shown in FIG. 1.

A drum for the conveyor is provided at each respective ends of the re-bale feeder to drive and/or guide the rotation of the conveyor 12. In a preferred form, one of the drums is a drive drum and the other is a free rotating drum which rotates due to the rotation of the drive drum and being linked by the preferred endless conveyor belt.

As shown in FIGS. 1 to 3, a free rotating drum 17 is provided a forward end of the re-bale feeder 10 and a drive drum is provided at the rear end of the re-bale feeder 10.

The conveyor can be driven in a forward and a reverse direction, as chosen by an operator.

The illustrated re-bale feeder 10 is constructed on a chassis formed from a pair of spaced apart, elongate side rails 19. The walls 14, 15 are typically mounted to an upper side of the side rails 19. The conveyor 12 is typically mounted between the side rails 19.

One or more transverse members may be provided extending between the side rails 19. A pair of hollow members 20 are provided extending between the side rails 19 to receive the tines of lifting apparatus to allow movement of the re-bale feeder 10.

A drive motor 18 is provided on the illustrated re-bale feeder 10 mounted relative to one of the side rails 19 of the chamber, relative to an outer surface of the side wall. The drive motor will typically be connected to a hydraulic circuit of a loader or tractor 60, one form of which is illustrated in FIG. 4.

In the illustrated embodiment, the drive motor 18 drives a drive shaft directly, the drive shaft mounting the drive drum at the rear end of the re-bale feeder.

The forward end 16 of the conveyor may be mounted for pivotal movement up and down. A drive device such as a ram for example, may be provided attached to one end of one or more mounting arms which is/are mounted in over centre configuration relative to a shaft with an opposite end of the one or more mounting arms associated with a portion of the conveyor 12. Raising and lowering the forward end of the conveyor can be undertaken to adjust the angle at which the material leaves the exit end 13 of the re-bale feeder 10.

A filler member 21 is provided substantially coplanar with the conveyor 12 at the rear of the chamber 11 to span any distance between the rear end of the conveyor 12 and the rear wall 15 of the chamber 11. This may help to prevent any material being lost between the rear end of the conveyor 12 and the rear wall 15 of the chamber 11.

The re-bale feeder 10 may be associated with one or more additional optional extra processing devices, various forms of which are illustrated in FIGS. 6 to 14.

One or more bale separators (cascades) 22 may be associated with the re-baler 10. The illustrated bale separators 22 comprise a pair of rotatable shafts with a series of blades being mounted to both shafts. The baled material can be fed into the separator 22 to break up the material in the bale to allow easier processing by the re-bale feeder 10.

In the illustrated form, the separator 22 includes an external frame with two horizontally mounted rotatable shafts and a series of blades being mounted on at least one of said shafts. The pair of shafts are coplanar and spaced apart. The shafts are typically both driven in rotation. The shafts counterrotate. The blades on the respective shafts will normally interleave with one another. The blades on the respective shafts typically cooperate to span the gap between the shafts to break up the baled material.

More than one separator 22 may be provided. For example, two separators 22 may be provided in a vertical stack as shown in FIGS. 6 to 14. Typically, the stack is provided above the chamber 11 of the re-bale feeder 10 so that gravity can feed the separated material into the chamber 11 of the re-bale feeder 10. The separators 22 offset 90° to one another, with the shafts in one of the separators 22 angled relative to the shafts in the other of the separators 22.

A hopper 23 may be provided above the stack to allow the insertion of a large amount of material or a large bale.

The stack may be fed in any way. For example, a bale handling apparatus 24 such as that described in PCT/GB2020/051334 could be used to provided feed material from a larger bale, into the hopper 23, stack and/or chamber 11. Alternatively, a conveyor 25 could be used in a larger, fixed assembly. As shown in FIGS. 6 to 14, the feed to the stack may be provided from any direction depending on access or desire.

A bale former is illustrated in FIGS. 4 to 5B. The bale former comprises a rotating loading roller 31 (obscured inside surround cage) with a plurality of radially extending members 32 (difficult to see) extending therefrom. A surround cage 33 surrounds at least a forward side of the loading roller 31, the surround cage 33 having a plurality of openings 34 therein to allow the radially extending members 32 of the rotating loading roller 31 to extend therethrough during rotation of the loading roller 31. A baling system 35 receives material 59 loaded by the loading roller 31 and forms the material into one or more bales.

The bale former 30 is typically used with a re-bale feeder 10 as shown in FIG. 4. The bale former 30 is preferably powered by hydraulics. Typically, the hydraulic circuit used will be the same as that used to power the re-bale feeder 10.

Typically, the speed of the re-bale feeder 10 will be matched to the processing speed of the bale former 30 in order that material 59 does not build up in the re-bale feeder 10 and/or the bale former 30, particularly around the loading roller 31.

The loading roller 31 will typically collect material 59 to provide to the baling system 35, preferably ensuring that the material 59 is separated to a degree allowing processing by the baling system 35. It is usually more efficient to form a bale from a smaller amount of material and adding o that amount as necessary, than attempting to reduce the size of material in the bale former, to form a bale.

Although obscured in the Figures, the rotating loading roller 31 will normally include a central shaft or drum. The central shaft or drum will normally be substantially cylindrical, although any shape could be used.

As shown, the loading roller 31 is typically laterally extending. The loading roller 31 will normally be horizontal. The loading roller 31 will normally be provided substantially perpendicularly to any feed of material 59, which in a preferred form includes the conveyor 12 of the re-bale feeder 10.

The loading roller 31 will typically rotate counterclockwise. The loading roller 31 will normally be rotating upwardly at an entry side of the loading roller 31.

Usually, a single loading roller 31 is provided.

A plurality of radially extending members 32 (difficult to see) is typically provided extending from the loading roller 31. The radial extending members 32 will typically be spaced over the length of the loading roller 31. The radial extending members 32 will typically be spaced circumferentially around the loading roller 31.

The radially extending members 32 will typically be elongate. The radially extending members 32 may have any shape. In the illustrated embodiment, the radially extending fingers 32 feed a screw conveyor 36 which feeds the baling system 35 in order to feed material 59 to the baling system 35.

The radially extending members 32 may be strengthened or reinforced given that a tip region of each of the radially extending members 32 will typically experience more force than the root of each of the radially extending members 32, as the radially extending members 32 move the material 59.

The screw conveyor 36 moves material 59 into the baling system 35 minimising the material 59 moving backwardly out of the baling system 35. The screw conveyor 36 drives material laterally relative to the loading roller 31, into the baling system 35.

The screw conveyor 36 is located relative to an upper side of the surround cage 33, above the loading roller 31 in order to move material 59 laterally across an upper portion of the surround cage 33, and into the baling system 35.

A transverse rail 37 extends above the loading roller 31 in the illustrated embodiment. The rail is substantially parallel to the loading roller 31, spaced above the loading roller 31 and toward the feed of material 59. A number of elongate fingers 38 extend from the rail 37, rearwardly toward the loading roller 31. The elongate fingers 38 typically function to hold the material 59 which is lifted by the radially extending members 32 of the loading roller 31, downwardly onto an upper side of the surround cage 33 to allow the material 59 to be collected by the screw conveyor 36 feeding the baling system 35. The elongate fingers 38 are angled downwardly and/or rearwardly toward the loading roller 31, on top of the surround cage 33. The elongate fingers 38 are interleaved with the radially extending members 32 on the loading roller 31 so that the elongate fingers 38 do not obstruct or strike the radially extending members 32 on the loading roller 31 as the loading roller 31 rotates.

The surround cage 33 will typically prevent or at least minimise the separated material 59 wrapping about the loading roller 31.

As shown in FIG. 5B, a feed side of the surround cage 33 will preferably be arcuate or curved. An upper portion of the surround cage 33 may be flattened to allow material 59 collected by the radially extending members 32 of the loading roller 31 to be deposited on top of the surround cage 33 to then be collected or moved by the screw conveyor 36.

The surround cage 33 will typically be formed from a number of spaced apart members, as shown. An opening 34 will preferably be provided between adjacent spaced apart members to allow the radially extending members 32 of the rotating loading roller 31 to extend therethrough during rotation of the loading roller 31. The openings 34 will typically be closely dimensioned, at least at a forward and upper side of the surround cage 33. This may reduce the amount of material 59 falling through the openings whilst the material 59 is being moved.

As illustrated, an outer surface of each of the spaced apart members is planar. Providing planar spaced apart members may assist with removal of the material 59 from the radially extending members 32 of the loading roller 31.

The surround cage 33 and/or the spaced apart members will typically be manufactured of metal or similar robust material.

In use, the radially extending members 32 on the loading roller 31 will typically collect material 59 from the conveyor 12 of the re-bale feeder 10 and lift the collected material 59 into a position in which the screw conveyor 36 which feeds the baling system 35 of the bale former 30 can act to move the material 59 into the baling system 35. The radially extending members 32 may assist with separation of material 59 as the material 59 is being collected and/or moved to the screw conveyor 36 which feeds the baling system 35.

The bale former 30 may include a baling system to receive material loaded by the loading roller and form the material 59 into one or more bales.

Any suitable baling system may be used. Many suitable baling systems or machines are produced by INT HARVESTER CO, for example those disclosed in U.S. Pat. No. 3,110,246 or United Kingdom Patent No. GB1504785.

According to a third aspect of the invention there is provided a re-baling apparatus as shown in FIGS. 4 to 5B, comprising:
a) a re-bale feeder 10 as described above; and
b) a bale former 30 positioned relative to the exit end of the re-bale feeder 10 to receive material 59 and form the material 59 into one or more bales.

In an embodiment, the lowered exit end 16 of conveyor 12 of the re-bale feeder 10 is located partially below the radially extending members 32 of the rotating loading roller 31 of the bale former 30 allowing the radially extending members 32 of the rotating loading roller 31 to collect the material 59 and move the collected material 59 from the re-bale feeder 10 and into the bale former 30.

FIGS. 15 to 17 is an axonometric view of an offset re-bale assembly with a re-bale feeder having a single level according to an embodiment.

In this configuration, the re-baler assembly 150 would be towed behind a tractor or similar driven vehicle (not shown), where the pick-up reel is offset, and the tractor drives alongside the swath (row) of straw or hay or haylage which is being baled in the field. The pickup reel picks up the straw or hay or haylage in the swath and lifts it to be dropped into the hopper 151.

The tractor and baler are both static. The tractor is positioned alongside the re-baler 152. The hopper 151 is flat on the tractor side (so as not to interfere with the tractor). The tractor drives the re-baler 152 from its external hydraulic services, preferably via a double acting two-way spool valve, to the hydraulic manifold 153 on the re-baler 152, which controls the motor 154 driving the speed of the belt feeding the baler and also control the speed of the horizontal rotors, which break down bale wafers/sections.

The double rotor agitators 156 are provided in a housing 155 and are spaced by 400-500 mm apart, providing clearance between rotors and for the tines on a tine bar 157, to direct the straw/hay towards the centre of the belt 158. The two tine bars 157 fit between the blades of the rotors 156, enabling variable resistance with the rotors 156 to break down the wafers depending on the bale and wafer material and type (grass hays have very different characteristics to cereal straws for example) therefore requiring different settings to the tines and/or the rotor 156. Consequently, grass hays may require 2-3 pairs of double outwardly counter rotating rotors to break bale wafers apart, one example of which is shown in FIGS. 18 to 20.

The lowest pair of tines below the rotors (157 on FIG. 17) deflect the loosened material towards the centre of the belt 158 feeding the bale former (not shown).

The horizontal tines 159 shown in FIG. 16 gently compress the swath of material to be denser, followed by two vertical tine bars 160 which narrow the swath (it is very important to present an even consistent swath to the bale former as failing to do so can form misshapen bales (like sausages, which will prove very problematic to any automated bale handling system, i.e. bale packers, bent bales cause havoc and mayhem after re-baling, so swath shape and structure is critical to a successful re-baling operation). Creating of an even field swath, to replicate an inside factory environment, makes the tines and deflectors critical to swath management.

FIGS. 18 to 20 show a re-bale assembly with a re-bale feeder similar to that illustrated in FIGS. 15 to 17 but having a pair of offset levels 155 of double rotor agitators 156. The levels re offset radially by 90° to one another.

FIGS. 21 to 23 show an inline re-bale assembly with power take off to attach to the driven vehicle and the baler and the structural box member extending through the re-bale feeder (with the rotor agitators removed for clarity).

Again, a hopper 210 is provided above a rectangular housing 211 through which a power take-off shaft extends. The power take-off shaft shown is divided into three parts with an articulated joint between each part. The first part 212 of the power take off shaft connects to the power take-off of the tractor or driver vehicle (not shown). The second part 213 of power take-off shaft connects to the bale former at the opposite end of the re-baler 152 to the tractor or driven vehicle. The third part of power take off shaft is provided within a structural box member 214 shown in FIG. 23 which protects the third part from the bale material. It is to be noted that the double rotor agitators are not shown in FIGS. 21 to 23 but would be located above the structural box member 214, one on either side thereof. Providing counterrotating double rotor agitators (rotating up in the centre and downwardly at the outside) helps divert bale material around the structural box member 214 and also helps to centre the bale material on the belt of the re-baler.

The one or more embodiments are described above by way of example only. Many variations are possible without departing from the scope of protection afforded by the appended claims.

1. A re-bale feeder comprising an open-topped box frame into which material is placed, a conveyor within the box frame operative to urge the material in a longitudinal direction towards an exit end.

2. The re-bale feeder as claimed in claim 1 wherein the open-topped box frame at least partially defines an internal volume into which separated material and/or one or more large bales are received the internal volume defined by a pair of upstanding side walls, rear wall, and a base, with an open exit end.

3. (canceled)

4. The re-bale feeder as claimed in claim 1 wherein the base wall of the re-bale feeder is substantially defined by an endless belt conveyor.

5. The re-bale feeder as claimed in claim 1 wherein a fixed, substantially solid base wall is provided with one or more bale chain drives with one or more engagement teeth extending upwardly from the chain drive within the re-bale feeder with an elongate opening for each of the bale chain drives so that the engagement teeth extend above a level of the base wall over a working length during rotation of the chain drive so that the engagement teeth of the chain drive engage bale material and drive the bale material toward the exit end.

6. The re-bale feeder as claimed in claim 5 wherein each of the bale chain drives and/or the conveyor can be driven in a forward and a reverse direction, as chosen by an operator.

7. The re-bale feeder as claimed in claim 1 wherein an exit end of the floor of the chamber is mounted for pivotal movement up and down.

8. The re-bale feeder as claimed in claim 1 further comprising at least one tine assembly extending onto the chamber to shape the material on the conveyor.

9. The re-bale feeder as claimed in claim 1 further comprising a drive motor provided on the re-bale feeder mounted relative to a side wall of the box frame.

10. The re-bale feeder as claimed in claim 1 constructed on a chassis formed from a pair of spaced apart, elongate side rails with a pair of hollow members provided extending between the side rails to receive tines of lifting apparatus to allow movement of the re-bale feeder.

11. A re-bale assembly comprising a re-bale feeder as claimed in claim 1 and one or more bale separator comprising one or more rotatable shafts, a series of blades being mounted on at least one of said shafts to receive baled material and to break up the baled material for feed into the re-bale feeder.

12. The re-bale assembly as claimed in claim 11 wherein the one or more bale separator includes an external frame with at least one horizontally mounted rotatable shafts, a series of blades being mounted on at least one of said shafts.

13. The re-bale assembly as claimed in claim 12 wherein a pair of coplanar, spaced apart shafts are provided.

14. The re-bale assembly as claimed in claim 13 wherein the shafts are both driven in rotation.

15. The re-bale assembly as claimed in claim 13 wherein the blades on the respective shafts interleave with one another and cooperate to span a gap between the spaced apart shafts to break up the baled material.

16. The re-bale assembly as claimed in claim 11 wherein more than one bale separators are provided in a vertical stack above the chamber of the re-bale feeder so that gravity can feed the separated material into the chamber of the re-bale feeder.

17. (canceled)

18. A bale former comprising a rotating loading roller with a plurality of radially extending members extending therefrom, a surround cage surrounding at least a forward side of the loading roller, the surround cage having a plurality of opening therein to allow the radially extending members of the rotating loading roller to extend therethrough during rotation of the loading roller, and a baling system to receive material loaded by the loading roller and form the material into one or more bales.

19-31. (canceled)

32. A re-baling apparatus comprising:
a) a re-bale feeder comprising an open-topped box frame into which material is placed, a conveyor within the box frame operative to urge the material in a longitudinal direction towards an exit end; and
b) a bale former positioned relative to the exit end of the re-bale feeder, the bale former comprising a rotating loading roller with a plurality of radially extending members extending therefrom, a surround cage surrounding at least a forward side of the loading roller, the surround cage having a plurality of openings therein to allow the radially extending members of the rotating loading roller to extend therethrough during rotation of the loading roller to grip the material at the exit end of the re-bale feeder, and a baling system to receive material loaded by the loading roller and form the material into one or more bales.

33. The re-baling apparatus as claimed in claim 32 wherein a lowered exit end of conveyor of the re-bale feeder is located partially below the radially extending members of the rotating loading roller allowing the radially extending members of the rotating loading roller to collect the material and move the collected material from the re-bale feeder and into the bale former.

34. The re-baling apparatus as claimed in claim 32 wherein the re-bale feeder is positioned to align the exit end of the re-bale feeder aligned with an entry end or loading roller of the bale former.

35. The re-baling apparatus as claimed in claim 34 wherein a width of the loading roller of the bale former corresponds to a width of the exit end of the re-bale feeder.

36. The re-baling apparatus as claimed in claim 35 wherein an exit end of the open-topped box frame corresponds in width to a width of the loading roller of the bale former allowing radially extending members of the loading roller to be received at least partially within the exit end of the re-bale feeder.
